(19) United States
(12) Patent Application Publication
(10) Pub. No.: US 2009/0102312 A1
(43) Pub. Date: Apr. 23, 2009

(54) INSULATOR AND ROTATING ELECTRIC MACHINE

(75) Inventor: Hiroyuki Tsukashima, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi, Aichi-ken (JP)

(21) Appl. No.: 12/301,734

(22) PCT Filed: May 16, 2007
(86) PCT No.: PCT/JP2007/060479

§ 371 Date: Nov. 20, 2008

(30) Foreign Application Priority Data
May 22, 2006 (JP) 2006-141228

(51) Int. Cl. H02K 3/34

(52) U.S. Cl. 310/215

(57) ABSTRACT

An insulator allowing a coil to be wound with large tension exerted and a rotating electric machine having the insulator are provided. An insulator (140) can be attached to stator teeth (110) such that the insulator has a coil wound thereon, and the insulator (140) includes a first member implemented as a framework (940) forming a framework of the insulator (140) and a second member implemented as a sheath (950) providing an external surface of the insulator (140) and providing insulation, and the framework (940) is larger in stiffness than the sheath (950).

### TECHNICAL FIELD

The present invention relates generally to insulators and rotating electric machines and particularly to insulators provided between a stator core and a stator coil and rotating electric machines having the insulator.

### BACKGROUND ART

Conventionally, insulators have involved techniques, for example as disclosed in Japanese Patent Laying-Open Nos. 2004-48908 (Patent Document 1), 2002-51491 (Patent Document 2) and 2005-51998 (Patent Document 3).

### DISCLOSURE OF THE INVENTION

In the conventional techniques, however, an insulator's strength limits tension applied in winding a coil. Accordingly the coil cannot be wound densely, and it has been difficult to provide miniaturized motors.

The present invention has been made in view of such disadvantage as above and it contemplates an insulator allowing a coil to be wound densely and a rotating electric machine having the insulator.

The present insulator is attachable to stator teeth while having a coil wound to the insulator and includes: a first member forming a framework of the insulator; and a second member forming an external surface of the insulator and having insulation, the first member being larger in stiffness than the second member.

The insulator thus configured is provided with a first member configuring a framework having large stiffness. Accordingly the insulator can be increased in strength. This allows a coil to be wound with increased tension exerted, and a miniaturized rotating electric machine can thus be provided.

Preferably, the coil is wound on the insulator. This can provide better productivity.

Preferably, a plurality of coils are wound concurrently. This can provide better productivity.

Preferably, the first member is provided only internal to a coil winding portion of the second member.

Preferably, the second member is configured of heat resistant resin.

Preferably, the second member is configured of thermoplastic resin.

Preferably, the first member is configured of rigid resin.

Preferably, the first member is configured of thermosetting resin.

Preferably, the first member is configured of metal.

The above described configurations may have at least two thereof combined together as appropriate.

The present rotating electric machine includes: stator teeth; the insulator as described above, fitted on the stator teeth; and a coil wound on the insulator.

The present invention can thus provide an insulator allowing a rotating electric machine to be miniaturized.

### BRIEF DESCRIPTION OF THE DRAWINGS

FIG. 1 schematically shows a configuration of a motored vehicle including an insulator according to one embodiment of the present invention.

FIG. 2 shows a stator including an insulator according to one embodiment of the present invention.

FIG. 3 shows the FIG. 2 stator provided with a resin mold.

FIG. 4 is a cross section taken along a line IV-IV shown in FIG. 3.

FIG. 5 is a perspective view of a framework.

FIG. 6 is a perspective view of the insulator.

FIG. 7 shows a cassette coil with a coil wound thereto.

FIG. 8 is a perspective view of a terminal module attached to the FIG. 3 stator.

FIG. 9 is an exploded perspective view of the terminal module attached to the FIG. 3 stator.

### BEST MODES FOR CARRYING OUT THE INVENTION

Hereinafter the present invention in embodiments will be described. Identical or corresponding components are identically denoted and may not be described repeatedly in detail.

If an embodiment described below refers to numbers, amounts and the like, the present invention is not necessarily limited in scope to such numbers, amounts or the like, unless otherwise specified. Furthermore, the embodiment describes components, which are not necessarily essential to the present invention, unless otherwise specified. Furthermore, if there is more than one embodiment hereinafter, each embodiment is originally intended to have a characteristic portion thereof combined with that of another embodiment, as appropriate, unless otherwise specified.

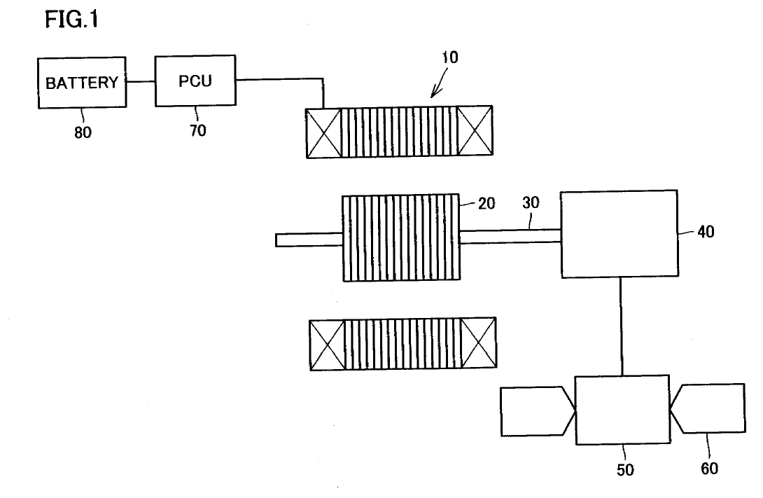

FIG. 1 shows a hybrid vehicle (HV) including a rotating electric machine according to one embodiment of the present invention. In the present specification, a “motored vehicle” is not limited to a hybrid vehicle and also includes for example a fuel cell vehicle, an electric vehicle and the like.

With reference to FIG. 1, the hybrid vehicle includes a stator 10, a rotor 20, a shaft 30, a reduction mechanism 40, a differential mechanism 50, a drive shaft receiving unit 60, a power control unit (PCU) 70, a battery 80 implemented by a chargeable and dischargeable secondary battery.

Stator 10 and rotor 20 configure a rotating electric machine (a motor generator) having a function serving as an eclectic motor or an electric power generator. Rotor 20 is assembled to shaft 30. Shaft 30 is supported via a bearing by a housing of a drive unit rotatably.

Stator 10 has a stator core in the form of a ring. The stator core is configured of iron, iron alloy or a similar magnetic material in the form of a plate deposited in layers. The stator core has an inner circumferential surface having a plurality of stator teeth and a slot formed between the stator teeth and serving as a recess. The slot opens toward a side inner than the stator core.

A stator coil including three winding phases, i.e., a U phase, a V phase and a W phase, is wound around a tooth to fit in a slot. The U phase, V phase and W phase are wound on a circumference offset from each other. The stator coil is connected through an electric power feeding cable to PCU 70. PCU 70 is electrically connected through an electric power feeding cable to battery 80. Thus battery 80 and the stator coil are electrically connected together.

The motor generator including stator 10 and rotor 20 outputs motive power which is in turn transmitted from reduction mechanism 40 through differential mechanism 50 to drive shaft receiving unit 60. Drive shaft receiving unit 60 receives driving power which is in turn transmitted through a drive shaft (not shown) to a wheel (not shown) as rotary force to allow the vehicle to travel.

In contrast, when the hybrid vehicle is regeneratively braked, the vehicle has wheels rotated by the vehicular body's inertial force. Rotary force received from the wheel drives the motor generator through drive shaft receiving unit 60, differential mechanism 50 and reduction mechanism 40. At the time, the motor generator operates as an electric power generator. The motor generator generates electric power which is in turn stored to battery 80 via an inverter internal to PCU 70.

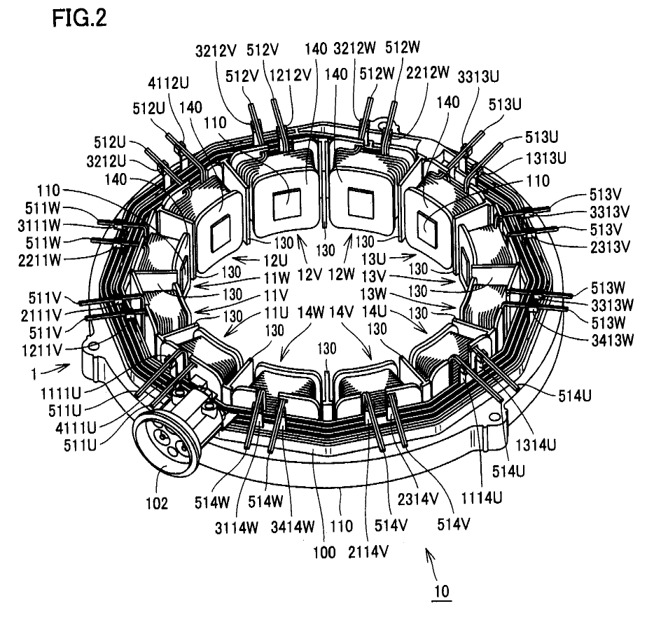

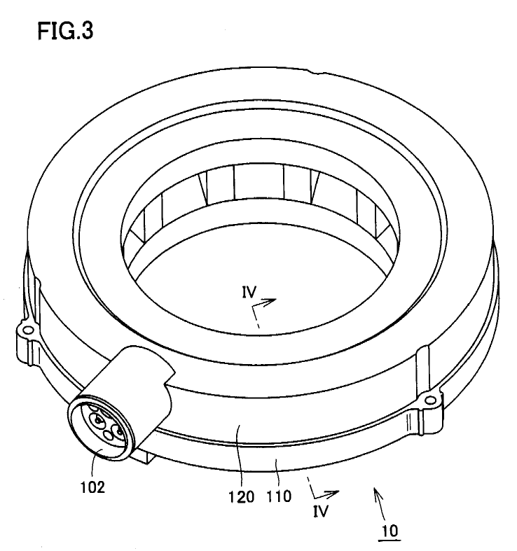

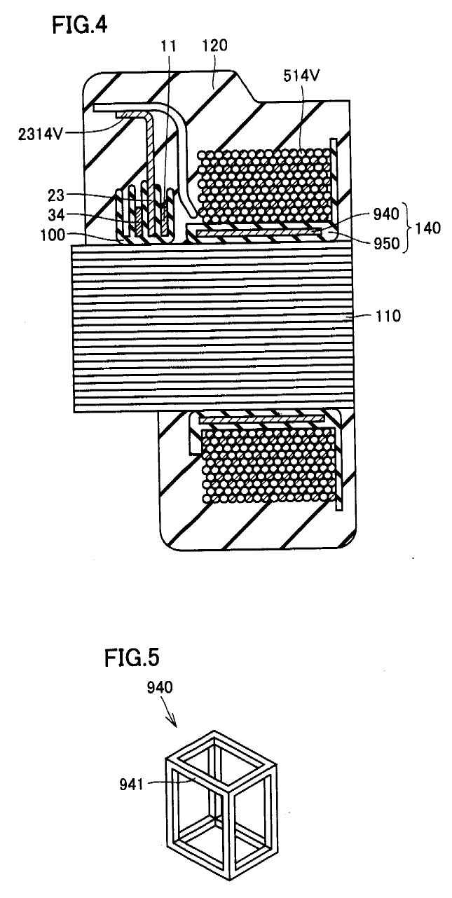

FIG. 2 and FIG. 3 show stator 10 in a perspective view before and after it is molded with resin, respectively. FIG. 4 is a cross section taken along a line IV-IV shown in FIG. 3. With reference to FIG. 2 to FIG. 4, stator 10 is configured including: stator teeth 110; a stator coil; a bus bar to which the stator coil is connected; a terminal module which is provided for the stator and to which the bus bar is attached; a resin mold 120; a diaphragm 130; and an insulator 140.

As shown in FIG. 2, the stator coil includes first to fourth U phase coils 11U to 14U, first to fourth V phase coils 11V to 14V, and first to fourth W phase coils 11W to 14W.

First U phase coil 11U is formed having conductive wire 511U wound to a tooth. Conductive wire 511U has one end connected to first U phase coil terminal 4111U, and the other end connected to first U phase coil terminal 1111U.

First V phase coil 11V is formed having conductive wire 511V wound to a tooth. Conductive wire 511V has one end connected to first V phase coil terminal 1211V, and the other end connected to first V phase coil terminal 2111V.

First W phase coil 11W is formed having conductive wire 511W wound to a tooth. Conductive wire 511W has one end connected to first W phase coil terminal 2211W, and the other end connected to first W phase coil terminal 3111W.

Second U phase coil 12U is formed having conductive wire 512U wound to a tooth. Conductive wire 512U has one end connected to second U phase coil terminal 3212U, and the other end connected to second U phase coil terminal 4112U.

Second V phase coil 12V is formed having conductive wire 512V wound to a tooth. Conductive wire 512V has one end connected to second V phase coil terminal 3212V, and the other end connected to second V phase coil terminal 1212V.

Second W phase coil 12W is formed having conductive wire 512W wound to a tooth. Conductive wire 512W has one end connected to second W phase coil terminal 3212W, and the other end connected to second W phase coil terminal 2112W.

Third U phase coil 13U is formed having conductive wire 513U wound to a tooth. Conductive wire 513U has one end connected to third U phase coil terminal 3313U, and the other end connected to third U phase coil terminal 1313U.

Third V phase coil 13V is formed having conductive wire 513V wound to a tooth. Conductive wire 513V has one end connected to third V phase coil terminal 3313V, and the other end connected to third V phase coil terminal 2213V.

Third W phase coil 13W is formed having conductive wire 513W wound to a tooth. Conductive wire 513W has one end connected to third W phase coil terminal 3313W, and the other end connected to third W phase coil terminal 3413W.

Fourth U phase coil 14U is formed having conductive wire 514U wound to a tooth. Conductive wire 514U has one end connected to fourth U phase coil terminal 1314U, and the other end connected to fourth U phase coil terminal 1114U.

Fourth V phase coil 14V is formed having conductive wire 514V wound to a tooth. Conductive wire 514V has one end connected to fourth V phase coil terminal 2314V, and the other end connected to fourth V phase coil terminal 2114V.

Fourth W phase coil 14W is formed having conductive wire 514W wound to a tooth. Conductive wire 514W has one end connected to fourth W phase coil terminal 3414W, and the other end connected to fourth W phase coil terminal 3114W.

Each coil terminal projects from a rail 100. The terminal has a recess to receive the conductive wire to ensure that the conductive wire and the terminal are connected together. Each coil is assembled to stator teeth 110 after the coil is wound on insulator 140 to be a cassette coil. Between coils, diaphragm 130 is provided to ensure that adjacent coils are insulated from each other. The coils are fitted on stator teeth 110.

With reference to FIGS. 3 and 4, the rail and coils located on stator teeth 110 are molded 120 with resin. This ensures that each coil is positioned as appropriate and that adjacent coils are insulated from each other. Such a resin mold as above is not limited to that formed as shown in FIGS. 3 and 4. Varnish or a like insulating resin may be applied on a surface of a coil to ensure that each coil is positioned as appropriate.

Insulator 140 has a first member implemented as a framework 940, and a second member implemented as a sheath 950 surrounding framework 940. Framework 940 serves as a framework of insulator 140 and forms a portion of insulator 140 that has a coil wound thereon. Framework 940 may be configured of conductor such as metal. Furthermore, it may be configured of material such as thermosetting resin or rigid resin. Insulator 140 is provided to insulate stator teeth 110 and conductive wire 514V from each other. Accordingly, if framework 940 is configured of conductor, framework 940 must be provided such that it does not connect conductive wire 514V and stator teeth 110 together.

FIG. 5 is a perspective view of the framework. With reference to FIG. 5, framework 940 has a structure formed of a plurality of squared beams 941 connected together and has an internally hollow, rectangular parallelepiped geometry. Framework 940 may not have the FIG. 5 rectangular parallelepiped geometry; it may be columnar, for example. Framework 940 has an outer periphery, on which a coil is wound.

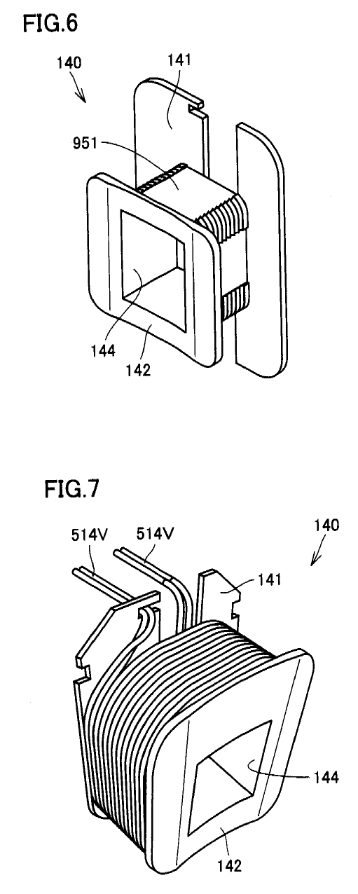

FIG. 6 is a perspective view of the insulator. With reference to FIG. 6, sheath 950 configuring insulator 140 is exposed at a surface of insulator 140. Insulator 140 has two flanges 141, 142, and therebetween a coil is wound. An opening 144 is a squared hollow region and receives stator tooth 110. Metal or rigid resin configures framework 940. Framework 940 is coated with an insulating material or molded with insulating resin to configure insulator 140 shown in FIG. 6. Directly on insulator 140 with the framework a coil is wound to configure a cassette coil. The coil is wound on a winding portion 951 configuring an external surface of insulator 140.

FIG. 7 shows a cassette coil with a coil wound thereto. With reference to FIG. 7, conductive wire 514V is wound on insulator 140 to configure the cassette coil. After coils are wound, stator teeth are inserted into opening 144.

In accordance with the present invention framework 940 can be strong and itself less deformable. Furthermore, the insulator that does not deform allows simplified facilities and a reduced winding cycle time, and can thus achieve reduced cost.

Furthermore, insulator 140 that does not significantly deform can accommodate automated assembling, and products of steady quality can thus be provided.

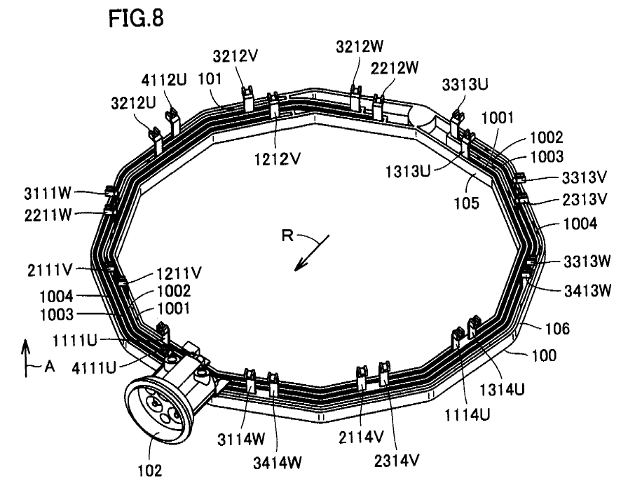

FIG. 8 is a perspective view of a terminal module attached to stator 10. With reference to FIG. 8, the terminal module includes rail 100. Rail 100 takes a ring (annular) shape of a regular dodecagon, formed to surround a predetermined space. The shape of rail 100 is not limited to a dodecagon, and may take any other polygonal shape. The shape of rail 100 is determined based on the number of cassette coils arranged in rail 100.

Rail 100 has an inner circumferential surface 105 and an outer circumferential surface 106. Both of inner and outer circumferential surfaces 105 and 106 are flat. Inner circumferential surface 105 and outer circumferential surface 106 are located at the inner circumferential side and outer circumferential side, respectively, of rail 100, extending circumferentially of rail 100. Rail 100 has a plurality of grooves 1001, 1002, 1003, and 1004.

Groove 1001 is located at the innermost side and groove 1002 is arranged at the outer circumferential side of groove 1001. Groove 1002 is arranged along and parallel to groove 1001. Groove 1003 is located at the outer side of groove 1002, arranged along and parallel to groove 1002. Groove 1004 is located at the outer side of groove 1003, arranged along and parallel to groove 1003.

A plurality of bus bars are fitted in groove 1001 to groove 1004. A coil terminal extends from the bus bar in the axial direction indicated by arrow A. First U phase coil terminals 1111U and 4111U, serving as electrodes for the U phase, are fitted in groove 1001 and fourth 1004, respectively. First V phase coil terminals 1211V and 2111V are fitted in groove 1001 and groove 1002, respectively. First W phase coil terminals 2111W and 3111W are fitted in groove 1002 and groove 1003, respectively.

Second U phase coil terminals 3212U and 4112U are fitted in groove 1003 and groove 1004, respectively. Second V phase coil terminals 3212V and 1212V are fitted in groove 1003 and groove 1001, respectively. Second W phase coil terminals 3212W and 2212W are fitted in groove 1003 and groove 1002, respectively.

Third U phase coil terminals 3313U and 1313U are fitted in groove 1003 and groove 1001. Third V phase coil terminals 3313V and 2313V are fitted in groove 1003 and groove 1002. Third W phase coil terminals 3313W and 3413W are fitted in groove 1003.

Fourth U phase coil terminals 1314U and 1114U are fitted in groove 1001. Fourth V phase coil terminals 2314V and 2114V are fitted in groove 1002. Fourth W phase coil terminals 3414W and 3114W are fitted in groove 1003.

Which terminal is to be fitted in which groove is not particularly limited, as long as the terminals are arranged to connect the U phase, V phase and W phase coils to allow the rotating electric machine to be driven.

A connector 102 is attached to rail 100. A metal terminal provided in connector 102 is connected to each bus bar.

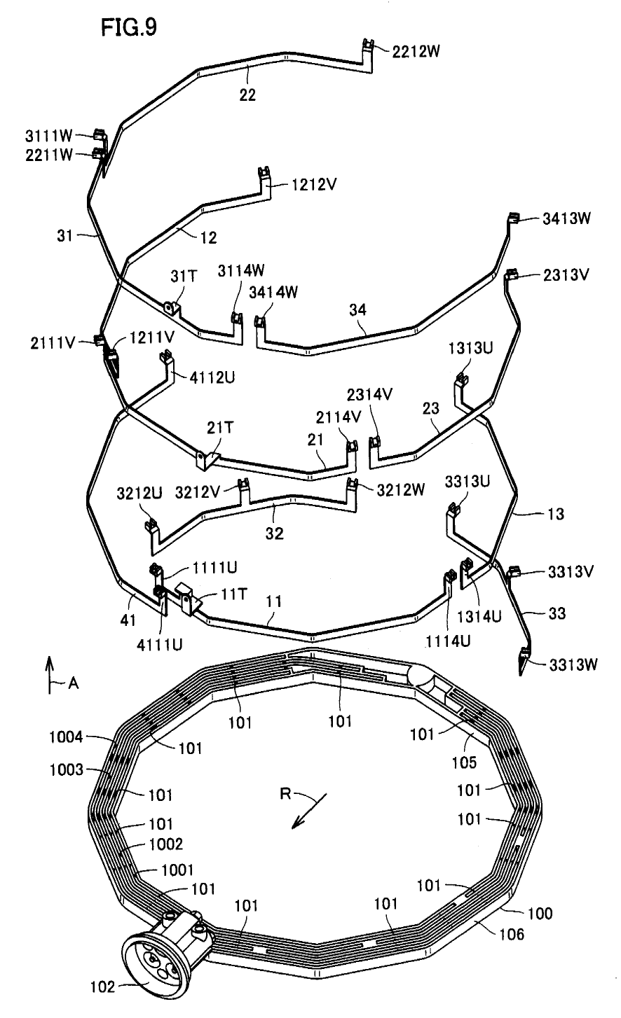

FIG. 9 is an exploded perspective view of a terminal module attached to stator 10. Referring to FIG. 9, rail 100 includes groove 1001, groove 1002, groove 1003, and groove 1004 in an annular shape. Each groove is formed interrupted in the course of its extension. A rib 101 to secure the bus bar is provided at groove 1001, groove 1002, groove 1003 and groove 1004. Rib 101 is configured to extend in the axial direction of the polygon (the direction indicated by arrow A). While in the FIG. 9 example at least one rib 101 is provided at one of the sides of the polygon, rib 101 may be absent from some of the sides. Furthermore, all ribs 101 may be absent. Furthermore, at least two ribs 101 may be provided per side to ensure pushing against the bus bar.

The bus bars include first bus bars 11-13, second bus bars 21-23, third bus bars 31-34, and a fourth bus bar 41.

First bus bars 11, 12 and 13 are fitted in groove 1001. First U phase coil terminal 1111U and fourth U phase coil terminal 1114U are provided at first bus bar 11. A connector terminal 11T is attached to first bus bar 11. Through connector terminal 11T electric power is supplied, and delivered to first bus bar 11. First V phase coil terminal 1211V and second V phase coil terminal 1212V are provided at first bus bar 12. Third U phase coil terminal 1313U and fourth U phase coil terminal 1314U are provided at first bus bar 13.

Second bus bars 21, 22, 23 are fitted in groove 1002. First V phase coil terminal 2111V and fourth V phase coil terminal 2114V are provided at second bus bar 21. Furthermore, a connector terminal 21T is attached to second bus bar 21. Through connector terminal 21T, electric power is supplied, and delivered to second bus bar 21. First W phase coil terminal 2211W and second W phase coil terminal 2212W are provided at second bus bar 22. Third V phase coil terminal 2313V and fourth V phase coil terminal 2314V are provided at second bus bar 23.

Third bus bars 31, 32, 33, 34 are fitted in groove 1003. Fourth W phase coil terminal 3114W and first W phase coil terminal 3111W are provided at third bus bar 31. A connector terminal 31T is attached to third bus bar 31. Through connector terminal 31T, electric power is supplied, and delivered to third bus bar 31. Second U phase coil terminal 3212U, second V phase coil terminal 3212V, and second W phase coil terminal 3212W are provided at third bus bar 32. Third U phase coil terminal 3313U, third V phase coil terminal 3313V, and third W phase coil terminal 3313W are provided at third bus bar 33. Third bus bars 32, 33 serve as a neutral point connecting the U, V and W phase coils. Third W phase coil terminal 3413W and fourth W phase coil terminal 3414W are provided at third bus bar 34.

Fourth bus bar 41 is fitted in groove 1004. First U phase coil terminal 4111U and second U phase coil terminal 4112U are provided at fourth bus bar 41.

Although FIG. 9 shows a 3-phase alternating current motor of star connection, the present invention is not limited thereto, and may be applied for example to a 3-phase coil motor of delta connection.

Stator teeth 110 are configured of electromagnetic steel plates, which can be secured together by welding, caulking or the like.

Insulator 140 can be attached to stator teeth 110 such that the insulator has a coil wound thereon, and insulator 140 includes a first member implemented as framework 940 forming a framework of insulator 140 and a second member implemented as sheath 950 providing an external surface of insulator 140 and providing insulation, and framework 940 is larger in stiffness than sheath 950. A U phase, a V phase and a W phase are configured of coils wound on insulator 140. This can achieve better productivity. Furthermore, a plurality of coils are wound concurrently. Framework 940 is provided only internal to coil winding portion 951 of sheath 950. This allows framework 940 to be minimally used. Sheath 950 may be configured of heat resistant resin or thermoplastic resin. If sheath 950 is configured of heat resistant resin, insulator 140 can be improved in heat resistant strength. If sheath 950 is configured of thermoplastic resin, it can contribute to better moldability. Framework 940 is not required to essentially have such significantly precise moldability and insulation as sheath 950 is. Accordingly, framework 940 may be configured of rigid resin, thermosetting resin or metal so as to satisfy its strength requirement.

The present rotating electric machine includes stator teeth 110, insulator 140 fitted on stator teeth 110, and first to fourth U phase coils 11U-14U, first to fourth V phase coils 11V-14V and first to fourth W phase coils 11W-14W wound on insulator 140.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

1. An insulator attachable to stator teeth while having a coil wound to the insulator, comprising:
a first member forming a framework of the insulator; and
a second member forming an external surface of the insulator and having insulation, said first member being larger in stiffness than said second member, wherein said first member has a hollow, rectangular parallelepiped structure formed of squared beams connected together.

2. The insulator according to claim 1, wherein said coil is wound on the insulator.

3. The insulator according to claim 2, wherein a plurality of coils are wound concurrently.

4. The insulator according to claim 1, wherein said first member is provided only internal to a coil winding portion of said second member.

5. The insulator according to claim 1, wherein said second member is configured of heat resistant resin.

6. The insulator according to claim 1, wherein said second member is configured of thermoplastic resin.

7. The insulator according to claim 1, wherein said first member is configured of rigid resin.

8. The insulator according to claim 1, wherein said first member is configured of thermosetting resin.

9. The insulator according to claim 1, wherein said first member is configured of metal.

10. A rotating electric machine comprising:
stator teeth;
an insulator according to claim 1 and fitted on said stator teeth; and
a coil wound on said insulator.

11. The rotating electric machine according to claim 10, further comprising a mold member molding said stator teeth, said insulator and said coil.

12. The insulator according to claim 1, wherein said first member has a first hole receiving said stator teeth and a second hole provided at a surface on which said coil is wound.

13. (canceled)
